(19) United States
(12) Patent Application Publication
(10) Pub. No.: US 2023/0171590 A1
(43) Pub. Date: Jun. 1, 2023

(54) CAPABILITY INFORMATION FOR A USER EQUIPMENT

(71) Applicant: QUALCOMM Incorporated, San Diego, CA (US)

(72) Inventors: Mona AGRAWAL, San Diego, CA (US); Arvind Vardarajan SANTHANAM, San Diego, CA (US); Daniel AMERGA, San Diego, CA (US); Girish KHANDELWAL, San Diego, CA (US); Roland RICK, Winter Park, CO (US); Danyang CONG, San Diego, CA (US); Sarath Kumar PUJARI, Hyderabad (IN); Prashant DOGRA, San Diego, CA (US); Vijay MARWAH, San Diego, CA (US)

(21) Appl. No.: 17/922,213

(22) PCT Filed: Jun. 1, 2021
(86) PCT No.: PCT/US21/35229

§ 371 Date: Oct. 28, 2022

(30) Foreign Application Priority Data
Jun. 1, 2020 (IN) 202041022928

(51) Int. Cl. H04W 8/24

(52) U.S. Cl. CPC H04W 8/24; H04W 84/042

(57) ABSTRACT

Aspects relate to a UE adapting the capability it advertises based on the network within which the UE is operating. In some examples, if a network currently supports a certain bandwidth, the UE may select the capabilities it will advertise based on that supported bandwidth. In some examples, a UE may acquire information regarding which configurations were considered by a network. In this case, the UE may select the capabilities it will advertise based on such configurations.

### CROSS-REFERENCE TO RELATED APPLICATIONS

The present application for patent claims priority to and the benefit of pending India Provisional Patent Application No. 202041022928, titled “CAPABILITY INFORMATION FOR WIRELESS COMMUNICATION DEVICE” filed Jun. 1, 2020, and assigned to the assignee hereof and hereby expressly incorporated by reference herein as if fully set forth below in its entirety and for all applicable purposes.

### TECHNICAL FIELD

The technology discussed below relates generally to wireless communication and, more particularly, to the selection and communication of capability information for a user equipment.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second BS.

A BS may schedule access to a cell to support access by multiple UEs. For example, a BS may allocate different resources (e.g., time domain and frequency domain resources) for different UEs operating within a cell of the BS. In addition, in a scenario where a UE supports multiple radio frequency (RF) carriers, the BS may schedule the UE on one or more RF carriers.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a method for wireless communication at a user equipment is disclosed. The method may include determining a first bandwidth supported by a first network for a first radio access technology (RAT), selecting a first processing capability of a plurality of processing capabilities of the user equipment based on the first bandwidth supported by the first network for the first RAT, and transmitting an indication of the first processing capability.

In some examples, a user equipment may include a transceiver, a memory, and a processor coupled to the transceiver and the memory. The processor and the memory may be configured to determine a first bandwidth supported by a first network for a first radio access technology (RAT), select a first processing capability of a plurality of processing capabilities of the user equipment based on the first bandwidth supported by the first network for the first RAT, and transmit an indication of the first processing capability via the transceiver.

In some examples, a user equipment may include means for determining a first bandwidth supported by a first network for a first radio access technology (RAT), means for selecting a first processing capability of a plurality of processing capabilities of the user equipment based on the first bandwidth supported by the first network for the first RAT, and means for transmitting an indication of the first processing capability.

In some examples, an article of manufacture for use by a user equipment includes a non-transitory computer-readable medium having stored therein instructions executable by one or more processors of the user equipment to determine a first bandwidth supported by a first network for a first radio access technology (RAT), select a first processing capability of a plurality of processing capabilities of the user equipment based on the first bandwidth supported by the first network for the first RAT, and transmit an indication of the first processing capability.

In some examples, a method for wireless communication at a user equipment is disclosed. The method may include determining that a first network has misconfigured at least one resource for the user equipment a number of times that is greater than or equal to a threshold. The at least one resource may be for communication via a first radio access technology (RAT) and a second RAT. The method may also include selecting a first processing capability of a plurality of processing capabilities of the user equipment based on the determining that the first network has misconfigured the at least one resource for the user equipment the number of times that is greater than or equal to the threshold. The method may further include maintaining an indication of the first processing capability for subsequent communication with the first network.

In some examples, a user equipment may include a transceiver, a memory, and a processor coupled to the transceiver and the memory. The processor and the memory may be configured to determine that a first network has misconfigured at least one resource for the user equipment a number of times that is greater than or equal to a threshold. The at least one resource may be for communication via a first radio access technology (RAT) and a second RAT. The processor and the memory may also be configured to select a first processing capability of a plurality of processing capabilities of the user equipment based on the determination that the first network has misconfigured the at least one resource for the user equipment the number of times that is greater than or equal to the threshold. The processor and the memory may further be configured to maintain an indication of the first processing capability for subsequent communication with the first network.

In some examples, a user equipment may include means for determining that a first network has misconfigured at least one resource for the user equipment a number of times that is greater than or equal to a threshold. The at least one resource may be for communication via a first radio access technology (RAT) and a second RAT. The user equipment may also include means for selecting a first processing capability of a plurality of processing capabilities of the user equipment based on the determining that the first network has misconfigured the at least one resource for the user equipment the number of times that is greater than or equal to the threshold. The user equipment may further include means for maintaining an indication of the first processing capability for subsequent communication with the first network.

In some examples, an article of manufacture for use by a user equipment includes a non-transitory computer-readable medium having stored therein instructions executable by one or more processors of the user equipment to determine that a first network has misconfigured at least one resource for the user equipment a number of times that is greater than or equal to a threshold. The at least one resource may be for communication via a first radio access technology (RAT) and a second RAT. The computer-readable medium may also have stored therein instructions executable by one or more processors of the user equipment to select a first processing capability of a plurality of processing capabilities of the user equipment based on the determination that the first network has misconfigured the at least one resource for the user equipment the number of times that is greater than or equal to the threshold. The computer-readable medium may further have stored therein instructions executable by one or more processors of the user equipment to maintain an indication of the first processing capability for subsequent communication with the first network.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic diagram illustrating organization of wireless resources in an air interface utilizing orthogonal frequency divisional multiplexing (OFDM) according to some aspects.

FIG. 4 is a conceptual illustration of a multi-cell transmission environment according to some aspects.

FIG. 5 is a conceptual illustration of an example of a user equipment communicating via Long Term Evolution (LTE) and New Radio (NR) technologies according to some aspects.

FIG. 6 is a signaling diagram illustrating an example of communicating capability information according to some aspects.

FIG. 7 is a conceptual illustration of an example of network configuration options according to some aspects.

FIG. 8 is a conceptual illustration of another example of network configuration options according to some aspects.

FIG. 9 is a signaling diagram illustrating an example of signaling associated with user equipment capabilities according to some aspects.

FIG. 10 is a block diagram conceptually illustrating an example of a hardware implementation for a user equipment employing a processing system according to some aspects.

FIG. 11 is a flow chart illustrating an example of processing capability selection according to some aspects.

FIG. 12 is a flow chart illustrating an example of maintaining an indication of a selected processing capability according to some aspects.

FIG. 13 is a flow chart illustrating an example of requesting a resource reconfiguration according to some aspects.

FIG. 14 is a flow chart illustrating another example of processing capability selection according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

A user equipment (UE) may have a defined set of capabilities. For example, a UE may support communication over a range of bandwidths up to a certain maximum bandwidth. As another example, a UE may support communication via one or more multiple-input multiple-output (MIMO) layers up to a maximum number of MIMO layers.

In some scenarios, a network may configure resources for the UE without adequately considering the capability of the UE. Various aspects of the disclosure relate to the selection and communication of capability information for a UE based at least in part on how a network may configure resources for the UE.

In some examples, a UE may adapt the capabilities that it advertises based on the network within which the UE is currently operating. For example, if a network (or a subset of the network) currently supports up to a certain bandwidth, the UE may alter its capabilities advertisement to exclude bandwidths that exceed the bandwidth supported by the network.

In some examples, a UE may acquire information regarding which configurations a network (or a subset of the network) has considered in configuring resources for the and/or one or more other UEs. In this case, the UE may update its advertisement rules to advertise capabilities based on these configurations.

In some examples, a UE may request that a network adapt a resource configuration based on the UE's capabilities. For example, in response to a resource misconfiguration by the network, the UE may send a message to the network requesting that the network modify the resource configuration.

In some examples, a UE may proactively send a message to the network to request a particular resource configuration. For example, the UE may send such a message in anticipation of the UE's future bandwidth needs.

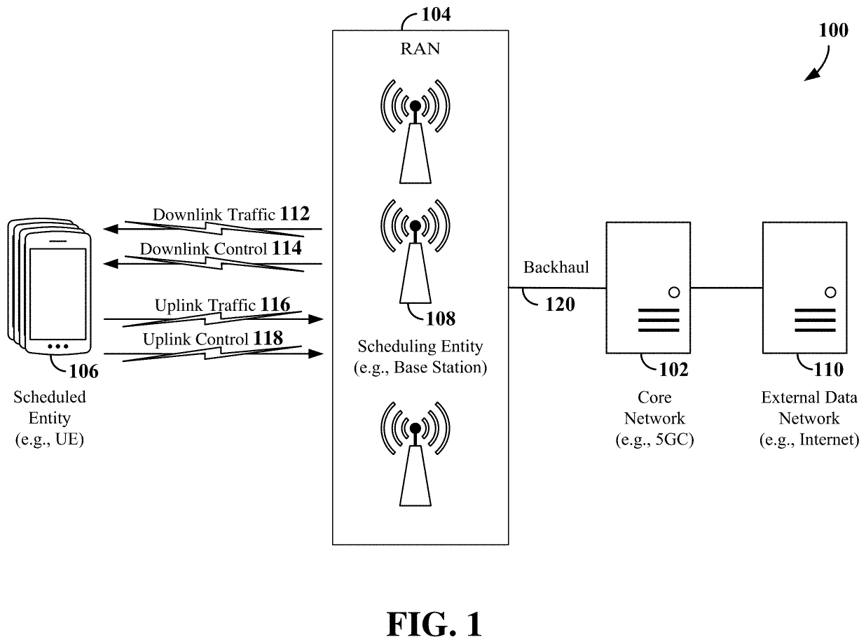

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network—New Radio dual connectivity (EN-DC) UE that is capable of simultaneously connecting to an LTE base station and a NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 and/or uplink control information 118 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

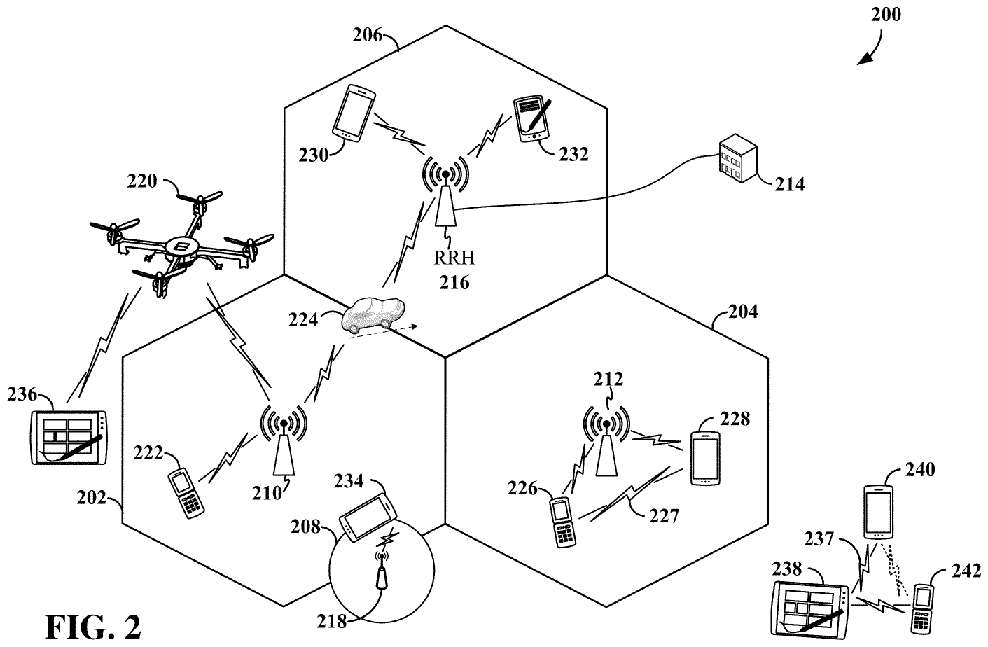

Referring now to FIG. 2, by way of example and without limitation, a schematic illustration of a RAN 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the radio access network 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A radio access network 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of the serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each

UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the radio access network 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), also known as flexible duplex.

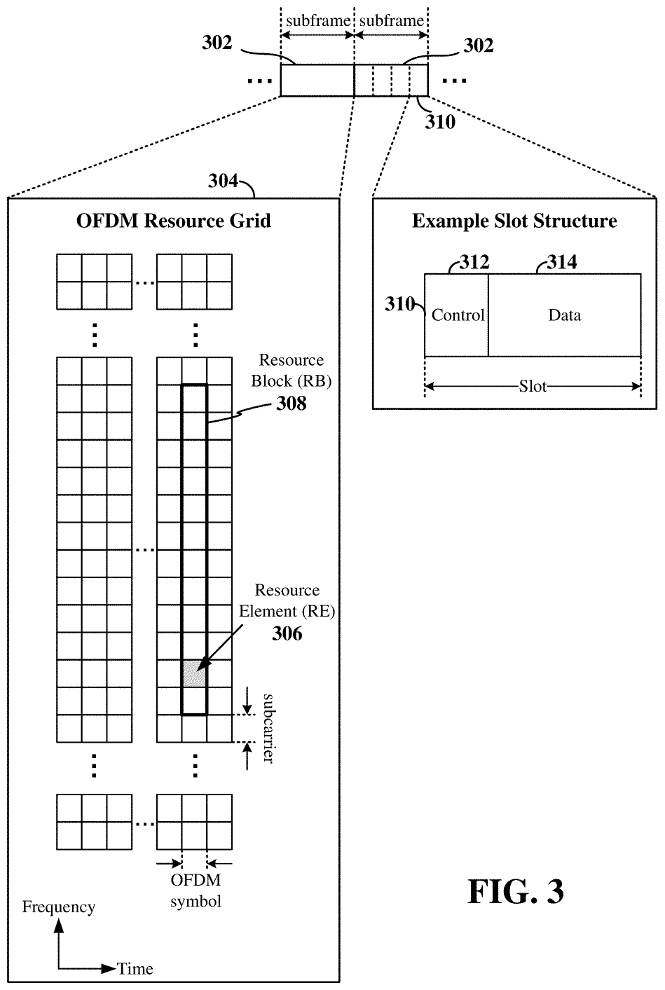

Various aspects of the present disclosure will be described with reference to an OFDM waveform, an example of which is schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an example subframe 302 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time—frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely an example, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-3 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

5G-NR networks may support carrier aggregation (CA) of component carriers (CCs) transmitted from different cells and/or different transmission and reception points (TRPs) in a multi-cell transmission environment. The different TRPs may be associated with a single serving cell or multiple serving cells. In some aspects, the term component carrier (CC) may refer to a carrier frequency (or band) utilized for communication within a cell.

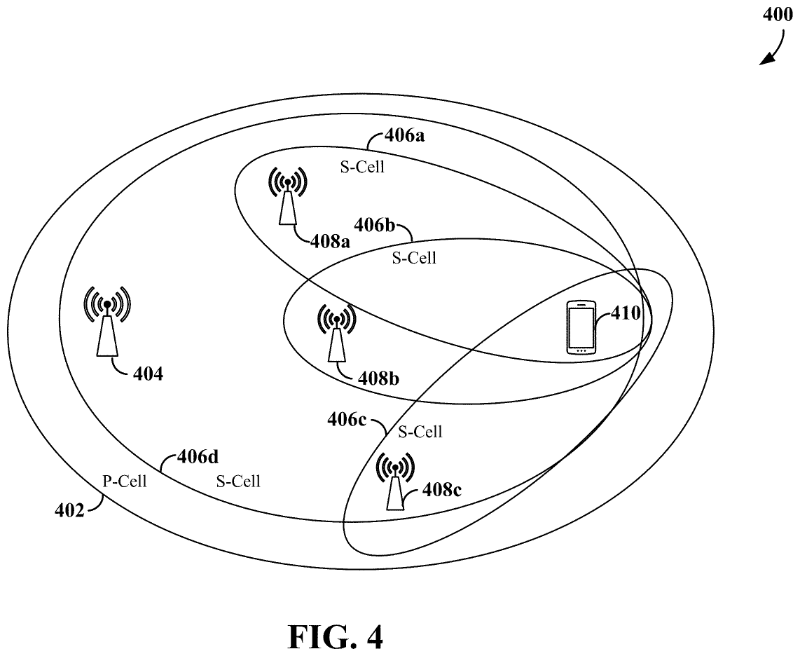

FIG. 4 is a diagram illustrating a multi-cell transmission environment 400 according to some aspects. The multi-cell transmission environment 400 includes a primary serving cell (PCell) 402 and one or more secondary serving cells (SCells) 406a, 406b, 406c, and 406d. The PCell 402 may be referred to as the anchor cell that provides a radio resource control (RRC) connection to a UE (e.g., UE 410).

When carrier aggregation is configured in the multi-cell transmission environment 400, one or more of the SCells 406a-406d may be activated or added to the PCell 402 to form the serving cells serving the UE 410. In this case, each of the serving cells corresponds to a component carrier (CC). The CC of the PCell 402 may be referred to as a primary CC, and the CC of a SCell 406a-406d may be referred to as a secondary CC. In some examples, the UE 410 may correspond to any of the UEs or scheduled entities shown in any of FIGS. 1, 2, 5, 6, 9, and 10.

Each of the PCell 402 and the SCells 406a-406d may be served by a transmission and reception point (TRP). For example, the PCell 402 may be served by TRP 404 and each of the SCells 406a-406c may be served by a respective TRP 408a-408c. Each TRP 404 and 408a-408c may be a base station (e.g., gNB), remote radio head of a gNB, or other scheduling entity similar to those illustrated in any of FIGS. 1, 2, 5, 6, and 9. In some examples, the PCell 402 and one or more of the SCells (e.g., SCell 406d) may be co-located. For example, a TRP for the PCell 402 and a TRP for the SCell 406d may be installed at the same geographic location. Thus, in some examples, a TRP (e.g., TRP 404) may include multiple TRPs, each corresponding to one of a plurality of co-located antenna arrays, and each supporting a different carrier (different CC). However, the coverage of the PCell 402 and SCell 406d may differ since component carriers in different frequency bands may experience different path loss, and thus provide different coverage.

The PCell 402 is responsible not only for connection setup, but also for radio resource management (RRM) and radio link monitoring (RLM) of the connection with the UE 410. For example, the PCell 402 may activate one or more of the SCells (e.g., SCell 406a) for multi-cell communication with the UE 410 to improve the reliability of the connection to the UE 410 and/or to increase the data rate. In some examples, the PCell may activate the SCell 406a on an as-needed basis instead of maintaining the SCell activation when the SCell 406a is not utilized for data transmission/reception in order to reduce power consumption by the UE 410.

In some examples, the PCell 402 may be a low band cell, and the SCells 406 may be high band cells. A low band (LB) cell uses a CC in a frequency band lower than that of the high band cells. For example, the high band cells may each use a respective mmWave CC (e.g., FR2 or higher), and the low band cell may use a CC in a lower frequency band (e.g., sub-6 GHz band or FR1). In general, a cell using an FR2 or higher CC can provide greater bandwidth than a cell using an FR1 CC. In addition, when using above-6 GHz frequency (e.g., mmWave) carriers, beamforming may be used to transmit and receive signals.

In some examples, the PCell 402 may utilize a first radio access technology (RAT), such as LTE, while one or more of the SCells 406 may utilize a second RAT, such as 5G-NR. In this example, the multi-cell transmission environment may be referred to as a multi-RAT—dual connectivity (MR-DC) environment. One example of MR-DC is an Evolved-Universal Terrestrial Radio Access Network—New Radio dual connectivity (EN-DC) mode that enables a UE to simultaneously connect to an LTE base station and a NR base station to receive data packets from and send data packets to both the LTE base station and the NR base station.

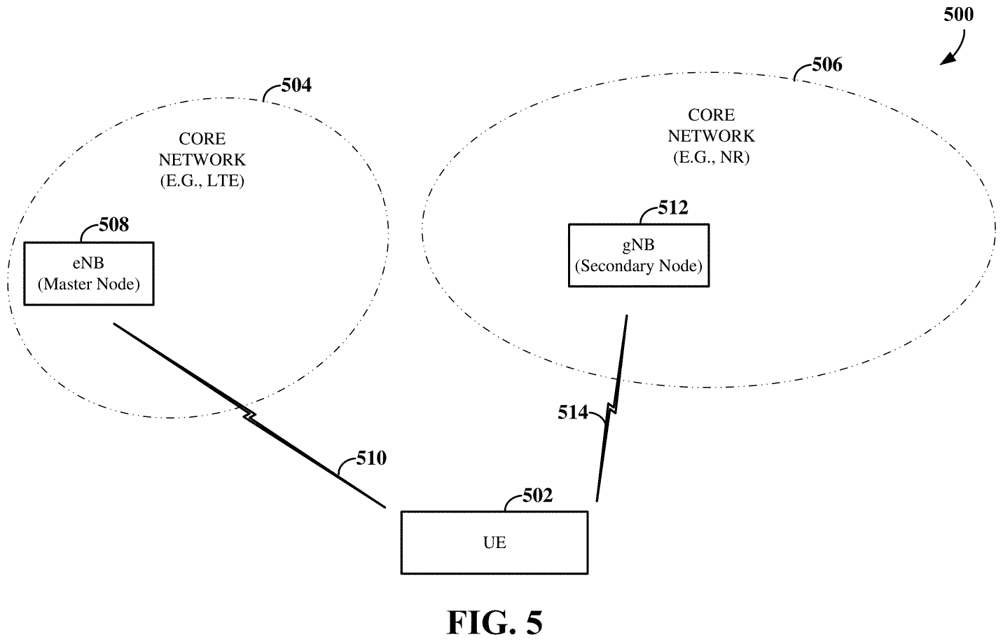

FIG. 5 illustrates an example of a wireless communication system 500 where a UE 502 may operate in an EN-DC mode. The wireless communication system 500 includes a first core network 504 (e.g., an LTE network) and a second core network 506 (e.g., an NR network), and potentially other networks (not shown). In some examples, the UE 502 may correspond to any of the UEs or scheduled entities shown in any of FIGS. 1, 2, 4, 6, 9, and 10.

For EN-DC mode, the UE 502 is connected to an eNB 508 of the first core network 504 via signaling 510 (e.g., LTE signaling, sub-6 signaling, etc.). In this example, the eNB 508 serves as the master node for the EN-DC mode. In some examples, the eNB 508 may correspond to any of the base stations or scheduling entities shown in any of FIGS. 1, 2, 4, 6, and 9.

The UE 502 is also connected to a gNB 512 of the second core network 506 via signaling 514 (e.g., NR signaling, millimeter wave signaling, etc.). In this example, the gNB 512 serves as a secondary node for the EN-DC mode of operation. In some examples, the gNB 512 may correspond to any of the base stations or scheduling entities shown in any of FIGS. 1, 2, 4, 6, and 9.

A given UE may have a particular capability. For example, a UE may support communication over a range of bandwidths up to a certain maximum bandwidth. As another example, a UE may support communication via one or more MIMO layers up to a maximum number of MIMO layers. In some aspects, one of more of these limitations may be due to the baseband processing capability and/or other processing capability of the UE.

In an EN-DC scenario, the baseband processing of a UE may support particular combinations of MIMO layers and bandwidths. For example, the UE may support up to a certain number of LTE layers and up to a certain aggregated bandwidth for NR.

Two examples of such UE capabilities follow. In these examples, the terms L1, L2, and L3 refer to different numbers of MIMO layers. As one non-limiting example, L1 may be 10 layers, L2 may be 20 layers, and L3 may be 30 layers. Thus, L1<L2<L3 layers. A different number of layers may be supported in other examples.

Also in the examples that follow, the term NR envelope refers in some aspects to the processing capability of the UE to support communication via one or more bands. For example, the term NR envelope may refer in some aspects to the throughput capability of the UE for NR communication.

In the first example UE capability, the terms B1, B2 and B3 refer to different bandwidths. As one non-limiting example, B1 may be 40 MHz, B2 may be 100 MHz, and B3 may be 200 MHz. Thus, B1<B2<B3 MHz bandwidth. Other sub-6 bandwidths may be supported in other examples.

In this first example, the UE may support LTE L1 layers+B3 MHz NR sub-6 TDD (which may be referred to as a maximum NR envelope). In addition, the UE may support LTE L3 layers+B1 MHz NR sub-6 TDD (which may be referred to as a ½ NR envelope). However, the UE does not support LTE L3 layers+B3 MHz NR Sub-6 TDD in this example.

In the second example UE capability, the terms B100, B200 and B300 refer to different bandwidths. As one non-limiting example, B100 may be 200 MHz, B200 may be 400 MHz, and B300 may be 600 MHz. Thus, B100<B200<B300 MHz bandwidth. Other millimeter wave bandwidths may be supported in other examples.

In this second example, the UE may support LTE L1 layers+B300 MHz NR mmW (maximum NR envelope). In addition, the UE may support LTE L3 layers+B100 MHz NR mmW (½ NR envelope). However, the UE does not support LTE L3 layers+B300 MHz NR mmW in this example.

If a network is configuring a UE with an EN-DC band combination, it may be desired in some examples that the network allocate for the UE the maximum NR bandwidth supported by the UE. The network may then allocate the LTE layers for the UE based on the advertised UE capability (e.g., the band combinations as described in the two examples above).

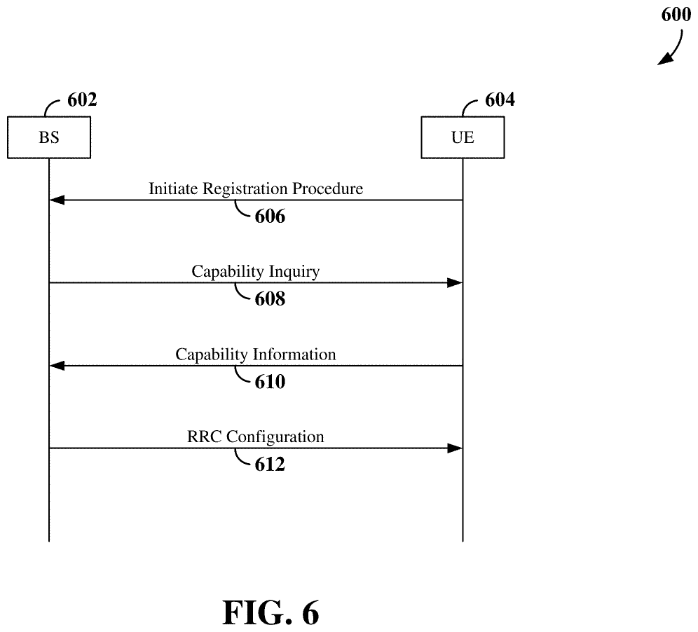

FIG. 6 is a diagram illustrating an example of signaling 600 associated with a network configuring a UE in a wireless communication network including a base station (BS) 602 and a user equipment (UE) 604. In some examples, the BS 602 may correspond to one or more of the scheduling entity 108 of FIG. 1, or the base station 210, 212, 214, or 216 of FIG. 2. In some examples, the UE 604 may correspond to one or more of the scheduled entity 106 (e.g., a UE, etc.) of FIG. 1, the UE 222, 224, 226, 228, 230, 232, 234, 238, 240, or 242 of FIG. 2, the UE 410 of FIG. 4, or the UE 502 of FIG. 5.

At 606 of FIG. 6, the UE 604 may initiate a registration procedure with the BS 602 to gain access to a network served by the BS 602. For example, the UE 604 may perform an initial cell search by detecting a PSS from the BS 602 (e.g., the PSS of a cell of the BS 602). The PSS may enable the UE 604 to synchronize to period timing of the BS 602 and may indicate a physical layer identity value assigned to the cell. The UE 604 may also receive an SSS from the BS 602 that enables the UE 604 to synchronize on the radio frame level with the cell. The SSS may also provide a cell identity value, which the UE 604 may combine with the physical layer identity value to identify the cell.

The UE 604 may then receive the MIB and SIBs broadcast by the BS 602 (e.g., as discussed above) to acquire information related to random access channel (RACH) procedures, physical channels, and so on. For example, SIB1 provides scheduling information and/or availability of other SIB types and/or information (e.g., public land mobile network (PLMN) information and/or cell barring information) that can guide a UE in performing cell selection and/or cell reselection. After acquiring the SI, the UE 604 may perform a random access procedure to initiate RRC connectivity with the BS 602.

At 608, the BS 602 may request capability information from the UE 604. For example, the BS 602 may transmit a UE capability inquiry to the UE 604 (e.g., via an RRC message).

At 610, the UE 604 may transmit its capability information to the BS 602. For example, the UE 604 may transmit a UE capability message to the BS 602 (e.g., via an RRC message).

At 612, the BS 602 may transmit an RRC configuration to the UE 604 (e.g., in conjunction with completing setting up a connection with the UE 604). In some examples, the RRC configuration may specify the resources (e.g., the number of layers and/or the bandwidth) to be used by the UE 604 when accessing one or more cells of the network.

In some scenarios, a network might not allocate resources for a UE in a preferred manner For example, an RRC configuration of 612 might not adequately take the capability information of the UE 604 (from step 610) into account.

As a specific example, a UE may advertise that it supports both ½ NR and maximum NR envelope band combinations as discussed above. Two example scenarios of a network allocating resources in a sub-optimal manner for this example follow.

In a first scenario (Case 1), the network might only be able to provide a B1 MHz allocation. Thus, in this case, the network can only support up to a maximum of B1 MHz on NR. In a sub-scenario for Case 1 (Subcase P1), the network might configure a UE based only on a check of the maximum NR envelope band combination. In this case, the network might only configure the minimum number of LTE layers (e.g., L1 layers) for the UE, rather than configuring the maximum number of (e.g., L3 layers) that the UE can support. For example, the network may configure the UE with L1 layers for LTE+B1 MHz for NR. This may lead to a lower throughput than can be supported by the UE.

In a second scenario (Case 2), the network might be able to provide a B3 MHz allocation. Thus, in this case, the network can support up to a maximum of B3 MHz on NR.

In a first sub-scenario for Case 2 (Subcase P1), the network may misconfigure a UE with the maximum NR bandwidth and the maximum number of LTE layers, a configuration that is not supported by the UE. For example, the network may configure the UE with L3 layers for LTE+B3 MHz for NR.

In a second sub-scenario for Case 2 (Subcase P2), the network may configure the UE with an ½ NR envelope (e.g., the network may prioritize assigning the maximum number of LTE layers). For example, the network may configure the UE with L3 layers for LTE+B1 MHz NR. This may lead to a lower throughput than can be supported by the UE.

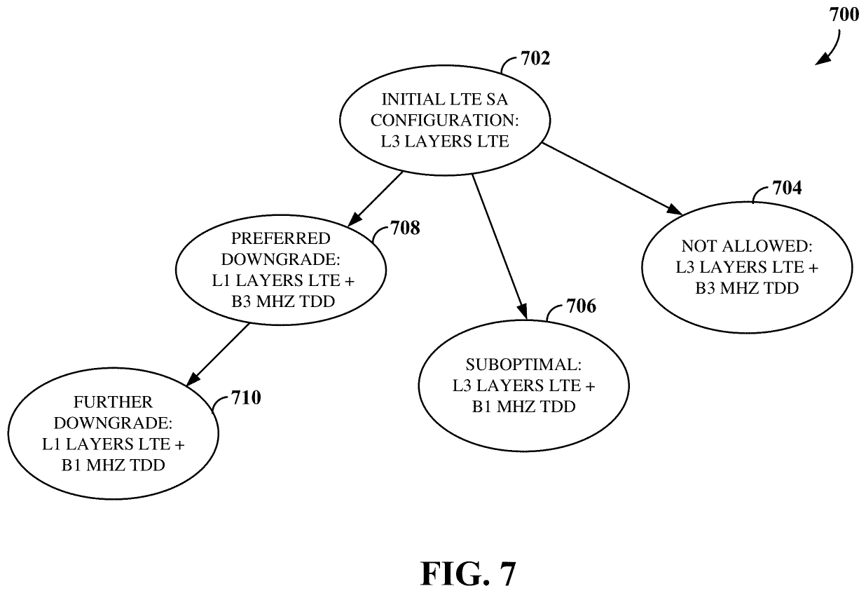

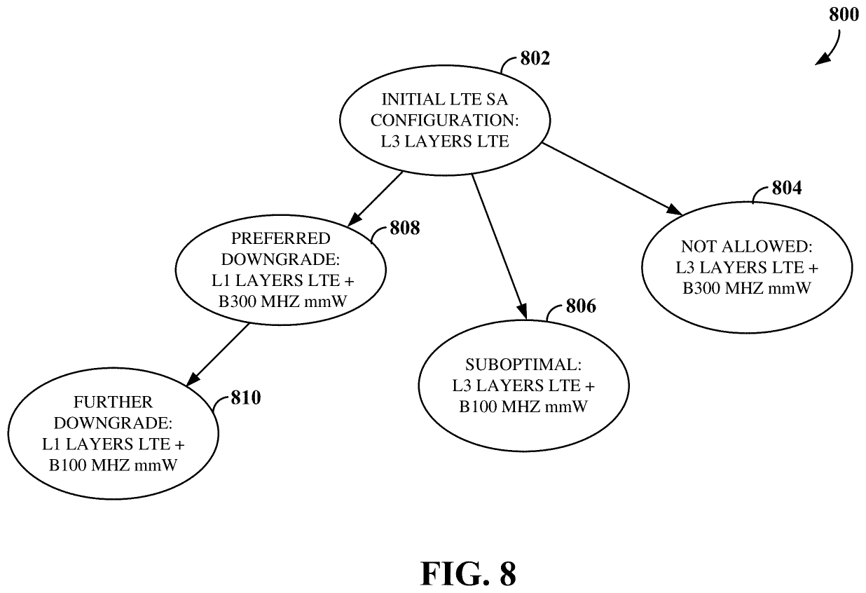

The issues that may arise in Case 1 and Case 2, as well as other configuration issues will be described with reference to FIGS. 7 and 8. FIG. 7 relates to the first example UE capability discussed above, while FIG. relates to the second example UE capability discussed above.

FIG. 7 illustrates an example of network configurations 700 for a UE in an example scenario. The network configurations 700 may be used, for example, for the first example UE capability discussed above (e.g., where the UE may support L1/L2/L3, and B1/B2/B3).

In an initial LTE standalone (SA) configuration 702, the network configures a UE with L3 layers for LTE. Subsequently, the network may configure the UE for EN-DC or some other dual connectivity configuration.

In a potential subsequent configuration 704, the network may attempt to configure the UE with B3 MHz TDD for NR (e.g., as in Case 2, Subcase P1 discussed above). Since this configuration is not supported by the UE, the UE may reject the NR configuration.

In an alternate potential subsequent configuration 706, the network may attempt to configure the UE with B1 MHz TDD for NR instead of B3 MHz TDD for NR. Thus, the configuration 706 is an example of Case 2, Subcase P2 discussed above. This configuration is supported by the UE; however, it may be a suboptimal configuration if the network is capable of supporting B3 MHz for NR. On the other hand, if the network is only capable of supporting B1 MHz for NR, this configuration may be acceptable.

In another alternate potential subsequent configuration 708, the network may downgrade the LTE by configuring the UE with L1 layers for LTE and B3 MHz TDD for NR. This configuration is supported by the UE and, thus, may be a preferred configuration.

In a potential subsequent configuration 710, the network may further downgrade the NR by configuring the UE with L1 layers for LTE and B1 MHz TDD for NR (e.g., as in Case 1, Subcase P1 discussed above). This configuration is supported by the UE but may be suboptimal (e.g., if the network can support an upgraded LTE configuration).

FIG. 8 illustrates an example of network configurations 800 for a UE in another example scenario. The network configurations 800 may be used, for example, for the second example UE capability discussed above (e.g., where the UE may support L1/L2/L3, and B100/B200/B300).

In an initial LTE standalone (SA) configuration 802, the network configures a UE with L3 layers for LTE. Subsequently, the network may configure the UE for EN-DC or some other dual connectivity configuration.

In a potential subsequent configuration 804, the network may also attempt to configure the UE with B300 MHz for NR (e.g., as in Case 2, Subcase P1 discussed above). Since this configuration is not supported by the UE, the UE may reject the NR configuration.

In an alternate potential subsequent configuration 806, the network may attempt to configure the UE with B1 MHz for NR instead of B3 MHz for NR. Thus, the configuration 706 is an example of Case 2, Subcase P2 discussed above. This configuration is supported by the UE; however, it may be a suboptimal configuration if the network is capable of supporting B3 MHz for NR. On the other hand, if the network is only capable of supporting B100 MHz for NR, this configuration may be acceptable.

In another alternate potential subsequent configuration 808, the network may downgrade the LTE by configuring the UE with L1 layers for LTE and B3 MHz for NR. This configuration is supported by the UE and, thus, may be a preferred configuration.

In a potential subsequent configuration 810, the network may further downgrade the NR by configuring the UE with L1 layers for LTE and B1 MHz for NR (e.g., as in Case 1, Subcase P1 discussed above). This configuration is supported by the UE but may be suboptimal (e.g., if the network can support an upgraded LTE configuration).

The disclosure relates in some aspects to steering the network towards a preferred combination (e.g., for a current network market) based on one or more of a PLMN, a frequency band, a tracking area identifier (TAI), or a geolocation. Two examples for different networks follow for Case 1, Subcase P1 and Case 2, Subcase P2 (described above) where the UE may advertise either' NR or the maximum NR envelope band combination based on the network that the UE is currently under.

In a first example network (e.g., in United Kingdom markets) that supports B1 MHz or less for an NR band, the UE may broadcast a capability of only the ½ NR envelope mode (e.g., the UE disables maximum NR) for a band combination involving that NR band. This may result in the UE advertising L3 layers+B1 MHz TDD. However, the UE would not advertise L1 layers+B3 MHz TDD. In some aspects, this may resolve potential issues with the Case 1, Subcase P1 scenario discussed above.

In a second example network (e.g., in German markets) that supports B1 MHz or higher for an NR band, the UE may broadcast a capability of the maximum NR envelope mode (e.g., the UE disables' NR) for a band combination involving that NR band. This may result in the UE advertising L1 layers+B3 MHz TDD. However, the UE would not advertise L3 layers+B1 MHz TDD. In some aspects, this may resolve potential issues with the Case 2, Subcase P2 scenario discussed above.

The capability advertisement by a UE may be based on information that the UE gathers from various resources. Examples of such resources may include crowd sourcing, finger printing, and static provisioning. For example, a UE may access a crowd sourcing server or some other entity or entities to share and obtain information that UEs have collected about the services provided by different networks over time (e.g., layers, bandwidths, etc.) and/or successful configurations and unsuccessful configurations of the UEs by the networks. Also, the UE may implement fingerprinting (e.g., data collection over time) to obtain information regarding the services provided by different networks over time and/or prior successful/unsuccessful configurations of the UE by the different networks. In addition, the UE may be statically configured (e.g., upon deployment) with information regarding the services provided by different networks. Each of these crowd sourcing, finger printing, and static provisioning techniques may be performed per PLMN, per TAI, per geolocation, per frequency, per frequency bands, etc.

The disclosure relates in some aspects to steering a UE towards valid band combinations that the network is able to configure. For example, for Case 2, Subcase P1 discussed above, a UE may keep track of (e.g., per PLMN) the most recent unique EN-DC envelopes (and associated NR band) that provided a successful network connection (e.g., the recent 10 configuration with following data per entry: <PLMN, NR Band, NR Envelope>).

In the event the network misconfigures the UE with an envelope that is not supported (e.g., a B3 MHz BW on an NR band Nx, with L3 layers in LTE), but includes a valid NR bandwidth advertised by the UE, the UE may take the following action. If the current failure is the k^{th} occurrence (e.g., for a particular PLMN, TAI, geolocation, or a combination thereof), the UE can update its network restriction list (e.g., <PLMN, envelopeRestrictionList>) or some other capability rule to include only' NR or MAX NR envelopes that were previously successful. The above entry can be retained in non-volatile memory across power cycles and deleted after a certain amount of time (e.g., in case the network fixes the issue).

The above solution can be extended to use cloud services (e.g., network servers), where each UE reports successful or unsuccessful band combination configurations from each network. A UE may then query the cloud service to identify which band combinations the UE should advertise based on what has been successful for other devices (e.g., other UEs).

The disclosure relates in some aspects to adapting a network's configuration to a UE's capability. Three examples follow.

In a first example, (Solution 1), a UE may attempt to reduce the number of configured LTE layers if the network's configuration exceeds the UE's supported envelope (e.g., Case 2, Subcase P1). For example, a UE may accept an RRC Reconfiguration from the network that is beyond the UE's envelope. However, the UE may report a channel quality indicator (CQI) below a certain threshold value (e.g., report CQI=0) on certain LTE SCells so that the network stops scheduling data on these LTE SCells. In this way, the UE may cause the network to configure the UE within the UE's envelope limit.

In a second example, (Solution 2), on NR, a UE may use a message to reduce the number of component carriers (CCs) and/or the aggregated bandwidth configured by the network (Case 2, Subcase P1). For example, the UE may send a UE Assistance Information message (e.g., which may be referred to as a UEAssistanceInformation message) to request the network to release SCells on NR to reduce the aggregated bandwidth configured for the UE.

In a third example, (Solution 3), a UE may force the network to add NR bandwidth instead of LTE component carriers (CCs) and/or layers. Here, a UE may monitor and/or estimate the throughput that it may need to support a particular communication. If the UE expects its future throughput needs to be relatively high or if the current throughput is already relatively high, the UE may send a message (e.g., a UEAssistanceInformation message) that requests the network to reduce the number of configured LTE layers. This may be done before sending an NR measurement (e.g., that meets a certain measurement criteria) to the NR network. Thus, the UE may cause the network to add more NR bandwidth instead of LTE CCs/layers in this case.

The disclosure relates in some aspects to adapting advertised UE capabilities based on network fragmentation. Some networks may have a fragmented deployment. For example, a network (e.g., a PLMN) may have B100 MHz allocated in some regions and B300 MHz allocated in other regions.

The disclosure relates in some aspects to dynamic radio capability update functionality in for situations where network fragmentation exists. A UE may build a knowledge base of which regions (e.g., based on GPS location, a TAI list, a cell ID, frequency, a frequency band, or a combination thereof) have a B100 MHz deployment and which regions have a B300 MHz deployment (or some other deployment). The knowledge base may be maintained within a UE and/or may be based on cloud services.

When the UE moves to a different region, the UE may initiate a registration procedure indicating that a radio capability update is needed (e.g., to confirm to the fragmentation). When the network sends a UE capability enquiry, the UE may send an updated list of band combinations based on the current region (include only ½ NR envelope or include only a maximum NR envelope). If both the UE and the network support radio capability signaling (RACS), the UE may use a service request procedure to switch between different UE radio capabilities (e.g., U1 and U2). This service request procedure result in the UE not needing to wait for the network to send the UE capability enquiry and thereby cause extensive over-the-air (OTA) signaling.

The disclosure relates in some aspects to dynamically updating (e.g., switching) between different UE radio capability IDs (URCIDs). As mentioned above, a UE can use a service request procedure to dynamically indicate which UE radio capability ID (URCID) to use. In an example scenario, a UE has URCIDs U1 and U2 assigned by the network through different registration procedures performed in past. Each URCID corresponds to different radio capability setting on UE. For example, U1 may correspond to UE capability information containing a certain list of band combinations (e.g., the first example UE capability discussed above) and U2 may correspond to UE capability information containing a different list of band combinations (e.g., the second example UE capability discussed above).

In a registration request, the UE can send URCID U1. Then, at a service request, depending upon the region, the UE can potentially request a switch to URCID U2. At the next service request, depending upon the region, the UE can potentially request a switch back to U1. The URCID may be a short pointer with defined format that is used to uniquely identify a set of UE radio capabilities (e.g., UE Radio Capability information). The UE Radio Capability ID may be assigned by the serving PLMN or by the UE manufacturer in some examples.

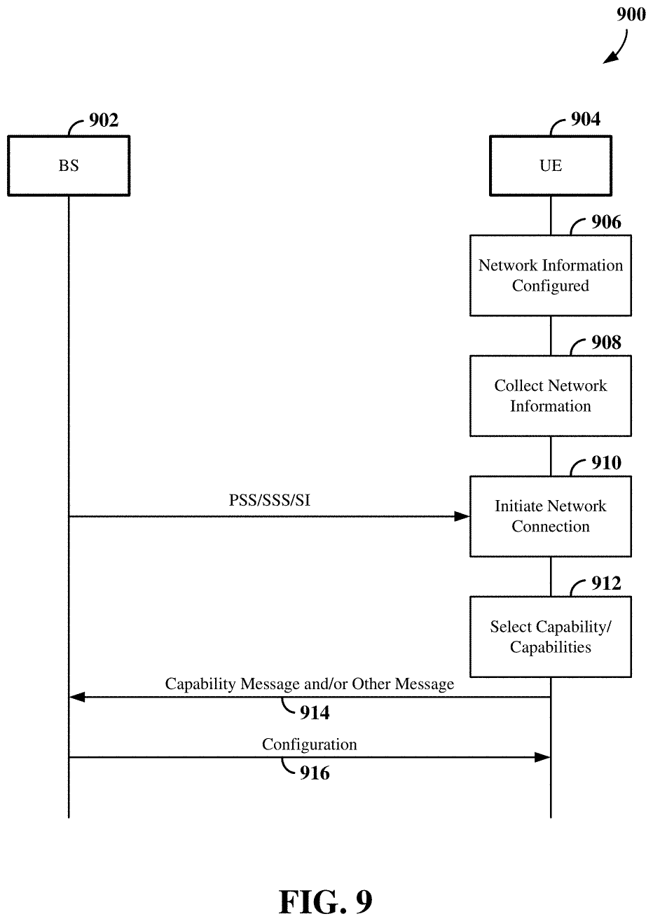

FIG. 9 is a signaling diagram 900 illustrating an example of signaling associated with user equipment capabilities in a wireless communication system including a base station (BS) 902 and a user equipment (UE) 904. In some examples, the BS 902 may correspond to any of the base stations or scheduling entities shown in any of FIGS. 1, 2, 4, 5, and 6. In some examples, the UE 904 may correspond to any of the UEs or scheduled entities shown in any of FIGS. 1, 2, 4, 5, 6, and 10.

At 906 of FIG. 9, the UE 904 may be configured (e.g., preconfigured) with information that the UE 904 may use for network access. For example, the UE may be configured (e.g., when the UE is activated by a carrier) with information regarding PLMNs, TAIs, and frequency bands that the UE 904 may use for network access. In addition, the UE 904 may be preconfigured with one or more URCIDs (as discussed above) in some examples.

At 908, the UE 904 may collect information about various networks over time. For example, as the UE 904 connects to different networks, the UE 904 may collect information about these connections. As another example, the UE 904 may connect to a crowd sourcing server or other devices to obtain network information collected by other UEs over time. This collected information may include, for example, the resources (e.g., layers, bandwidths, band combinations, etc.) supported by different networks, successful resource configurations by networks, unsuccessful resource configurations by networks, network fragmentation, and so on as discussed herein.

At 910, at some point in time, the UE 904 may attempt to connect to a network served by the BS 902. For example, the UE 904 may receive signals from the BS 902 that identify the network (e.g., identify the associated PLMN) as discussed herein.

At 912, the UE 904 may select at least one capability to advertise to the BS 902 based on the information collected by the UE 904 at 908. For example, the UE 904 may select a set of capabilities to advertise to the BS 902 based on the layers, bandwidths, and band combinations supported by the network, based on successful/unsuccessful resource configurations by the network, and so on as discussed herein. In some examples, the UE 904 may select a set of capabilities that will prevent the BS 902 from misconfiguring the UE 904.

At 914, the UE 904 may transmit a capabilities message including the capability (or capabilities) selected at 912 and/or transmit other information to the BS 902. Examples of other information that the UE 904 may transmit include messages that attempt to prevent a misconfiguration by the network (e.g., reporting a CQI=0, transmitting a UE Assistance Information message, and so on).

At 916, the BS 902 may configure the UE 904 based on the capabilities message of 914. For example, the BS 902 may transmit an RRC configuration message to the UE 904 that specifies the number of layers and bandwidths to be used by the UE 904.

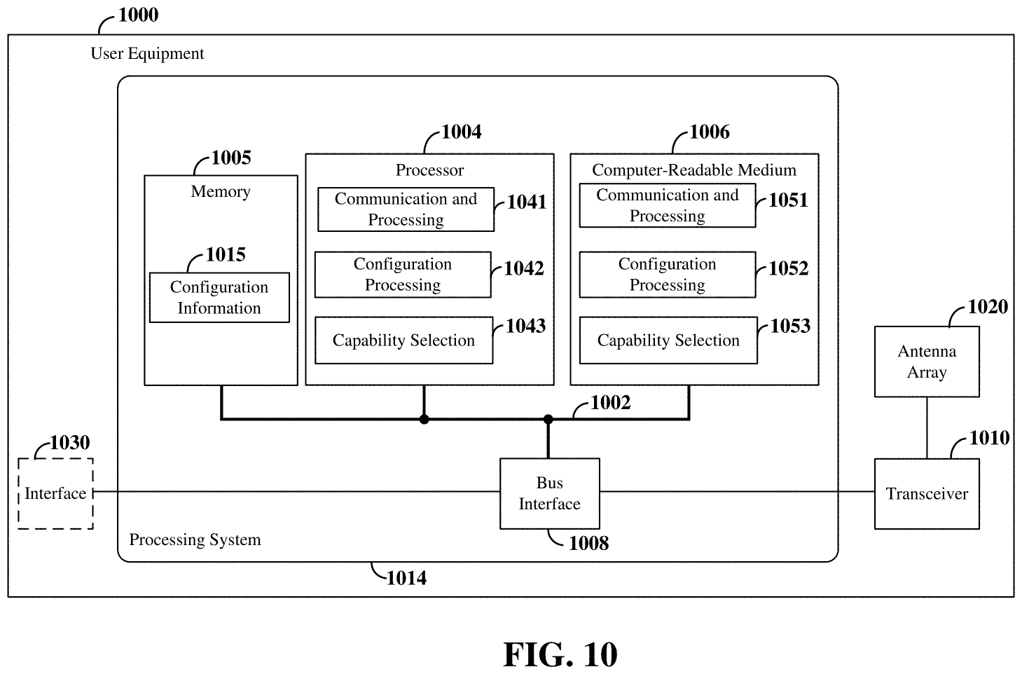

FIG. 10 is a block diagram illustrating an example of a hardware implementation for a UE 1000 employing a processing system 1014. For example, the UE 1000 may be a device configured to wirelessly communicate with a base station, as discussed in any one or more of FIGS. 1-9. In some implementations, the UE 1000 may correspond to any of the UEs or scheduled entities shown in any of FIGS. 1, 2, 4, 5, 6, and 9.

In accordance with various aspects of the disclosure, an element, or any portion of an element, or any combination of elements may be implemented with the processing system 1014. The processing system 1014 may include one or more processors 1004. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1000 may be configured to perform any one or more of the functions described herein. That is, the processor 1004, as utilized in a UE 1000, may be used to implement any one or more of the processes and procedures described herein.

The processor 1004 may in some instances be implemented via a baseband or modem chip and in other implementations, the processor 1004 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits including one or more processors (represented generally by the processor 1004), a memory 1005, and computer-readable media (represented generally by the computer-readable medium 1006). The bus 1002 may also link various other circuits such as timing sources, peripherals, voltage regulators, and power management circuits, which are well known in the art, and therefore, will not be described any further. A bus interface 1008 provides an interface between the bus 1002 and a transceiver 1010 and an antenna array 1020, and an interface between the bus 1002 and an interface 1030. The transceiver 1010 provides a communication interface or means for communicating with various other apparatus over a wireless transmission medium. The interface 1030 provides a communication interface or means of communicating with various other apparatuses and devices (e.g., other devices housed within the same apparatus as the UE or other external apparatuses) over an internal bus or external transmission medium, such as an Ethernet cable. Depending upon the nature of the apparatus, the interface 1030 may include a user interface (e.g., keypad, display, speaker, microphone, joystick). Of course, such a user interface is optional, and may be omitted in some examples, such as an IoT device.

The processor 1004 is responsible for managing the bus 1002 and general processing, including the execution of software stored on the computer-readable medium 1006. The software, when executed by the processor 1004, causes the processing system 1014 to perform the various functions described below for any particular apparatus. The computer-readable medium 1006 and the memory 1005 may also be used for storing data that is manipulated by the processor 1004 when executing software. For example, the memory 1005 may store configuration information 1015 used by the processor 1004 for communication operations as described herein.

One or more processors 1004 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1006.

The computer-readable medium 1006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may reside in the processing system 1014, external to the processing system 1014, or distributed across multiple entities including the processing system 1014. The computer-readable medium 1006 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

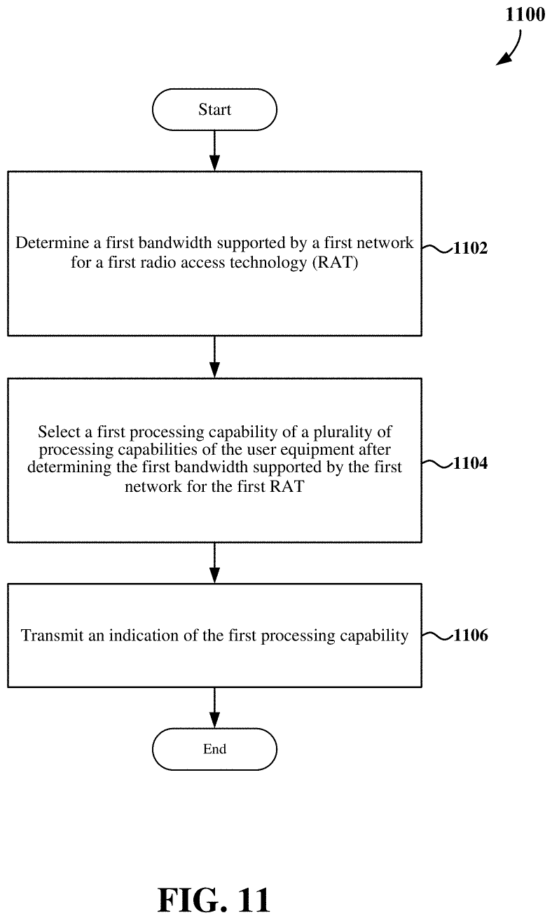

The UE 1000 may be configured to perform any one or more of the operations described herein (e.g., as described above in conjunction with FIGS. 1-9 and as described below in conjunction with FIGS. 11-14). In some aspects of the disclosure, the processor 1004, as utilized in the UE 1000, may include circuitry configured for various functions.

The processor 1004 may include communication and processing circuitry 1041. The communication and processing circuitry 1041 may be configured to communicate with a base station, such as a gNB. The communication and processing circuitry 1041 may include one or more hardware components that provide the physical structure that performs various processes related to wireless communication (e.g., signal reception and/or signal transmission) as described herein. The communication and processing circuitry 1041 may further include one or more hardware components that provide the physical structure that performs various processes related to signal processing (e.g., processing a received signal and/or processing a signal for transmission) as described herein. In some examples, the communication and processing circuitry 1041 may include two or more transmit/receive chains. The communication and processing circuitry 1041 may further be configured to execute communication and processing software 1051 included on the computer-readable medium 1006 to implement one or more functions described herein.

In some implementations where the communication involves receiving information, the communication and processing circuitry 1041 may obtain information from a component of the UE 1000 (e.g., from the transceiver 1010 that receives the information via radio frequency signaling or some other type of signaling suitable for the applicable communication medium), process (e.g., decode) the information, and output the processed information. For example, the communication and processing circuitry 1041 may output the information to another component of the processor 1004, to the memory 1005, or to the bus interface 1008. In some examples, the communication and processing circuitry 1041 may receive one or more of signals, messages, other information, or any combination thereof. In some examples, the communication and processing circuitry 1041 may receive information via one or more channels. In some examples, the communication and processing circuitry 1041 may include functionality for a means for receiving. In some examples, the communication and processing circuitry 1041 may include functionality for a means for decoding.

In some implementations where the communication involves sending (e.g., transmitting) information, the communication and processing circuitry 1041 may obtain information (e.g., from another component of the processor 1004, the memory 1005, or the bus interface 1008), process (e.g., encode) the information, and output the processed information. For example, the communication and processing circuitry 1041 may output the information to the transceiver 1010 (e.g., that transmits the information via radio frequency signaling or some other type of signaling suitable for the applicable communication medium). In some examples, the communication and processing circuitry 1041 may send one or more of signals, messages, other information, or any combination thereof. In some examples, the communication and processing circuitry 1041 may send information via one or more channels. In some examples, the communication and processing circuitry 1041 may include functionality for a means for sending (e.g., a means for transmitting). In some examples, the communication and processing circuitry 1041 may include functionality for a means for encoding.

The processor 1004 may include configuration processing circuitry 1042 configured to perform configuration processing-related operations as discussed herein. The configuration processing circuitry 1042 may be configured to execute configuration processing software 1052 included on the computer-readable medium 1006 to implement one or more functions described herein.

The configuration processing circuitry 1042 may include functionality for a means for determining a bandwidth supported by a network (e.g., a network within a particular country, region, etc.). For example, the configuration processing circuitry 1042 may be configured to identify the first network (or a fragmentation of the network) based on a PLMN, a frequency band, etc., and identify a bandwidth supported by the first network (e.g., by accessing a local database or a remote server such as a cloud-based server).

The configuration processing circuitry 1042 may include functionality for a means for determining that a network has misconfigured a resource for a user equipment. For example, the configuration processing circuitry 1042 may be configured to receive a configuration (e.g., via an RRC message) from a network and determine whether the configuration conforms to the capabilities of the user equipment.

The configuration processing circuitry 1042 may include functionality for a means for generating a message to induce a network to reconfigure at least one resource. For example, the configuration processing circuitry 1042 may be configured to generate a request for the network to reduce the number of LTE MIMO layers configured for the user equipment. As another example, the configuration processing circuitry 1042 may be configured to generate a UE Assistance Information message.

The configuration processing circuitry 1042 may include functionality for a means for identifying a region. For example, the configuration processing circuitry 1042 may be configured to receive signals from a network or another source (e.g., location information signals from a GPS satellite) to identify a PLMN, a cell ID, a frequency band, etc.

The processor 1004 may include capability selection circuitry 1043 configured to perform capability selection-related operations as discussed herein. The capability selection circuitry 1043 may further be configured to execute capability selection software 1053 included on the computer-readable medium 1006 to implement one or more functions described herein.

The capability selection circuitry 1043 may include functionality for a means for selecting a processing capability. For example, the capability selection circuitry 1043 may be configured to identify the UE capabilities (e.g., L3 Layers and B1 MHz, etc.) that do not exceed a bandwidth (e.g., B1 MHz, etc.) supported by a network. As another example, the capability selection circuitry 1043 may be configured to remove from a capabilities rule (or list) any capability combinations that correspond to unsuccessful configurations by the network.

The capability selection circuitry 1043 may include functionality for a means for transmitting an indication of a processing capability. For example, the capability selection circuitry 1043 may be configured to advertise the user equipment's capabilities (e.g., by transmitting a UE capability message).

The capability selection circuitry 1043 may include functionality for a means for maintaining an indication of a processing capability. For example, the capability selection circuitry 1043 may be configured to may update a list of successful configurations and unsuccessful configurations (e.g., by accessing a local database or a remote server such as a cloud-based server).

FIG. 11 is a flow chart illustrating an example method 1100 for wireless communication according to some aspects. As described below, some or all illustrated features may be omitted in a particular implementation within the scope of the present disclosure, and some illustrated features may not be required for implementation of all examples. In some examples, the method 1100 may be carried out by the user equipment 1000 illustrated in FIG. 10 or by any suitable apparatus or means for carrying out the functions or algorithm described below.

At block 1102, a user equipment may determine a first bandwidth supported by a first network for a first radio access technology (RAT). For example, the configuration processing circuitry 1042 (optionally in cooperation with the communication and processing circuitry 1041 and the transceiver 1010), shown and described above in connection with FIG. 10, may provide a means to determine a first bandwidth supported by a first network for a first radio access technology (RAT). In some examples, the first RAT may include a third generation partnership project (3GPP) new radio (NR) technology.

In some examples, the determination of the first bandwidth supported by the first network (e.g., supported by a base station of the network) for the first RAT by the user equipment may include identifying a public land mobile network (PLMN) advertised by the first network, and identifying a bandwidth associated with the PLMN. In some examples, the determination of the first bandwidth supported by the first network for the first RAT by the user equipment may include identifying a radio frequency (RF) band of the first network, and identifying a bandwidth associated with the RF band. In some examples, the determination of the first bandwidth supported by the first network for the first RAT by the user equipment may include identifying a tracking area identifier (TAI) advertised by the first network, and identifying a bandwidth associated with the TAI. In some examples, the determination of the first bandwidth supported by the first network for the first RAT by the user equipment may include identifying a location of the user equipment, and identifying a bandwidth associated with the location.

In some examples, the determination of the first bandwidth supported by the first network for the first RAT by the user equipment may include retrieving information indicative of the first bandwidth from a server. In some examples, the determination of the first bandwidth supported by the first network for the first RAT by the user equipment may include collecting information indicative of the first bandwidth based on a plurality of accesses of the first network by the user equipment. In some examples, the determination of the first bandwidth supported by the first network for the first RAT by the user equipment may include retrieving defined information indicative of the first bandwidth from a memory of the user equipment.

In some examples, the first bandwidth is for a sub-6 GHz band. In some examples, the first bandwidth is for a millimeter wave (mmW) band.

At block 1104, the user equipment may select a first processing capability of a plurality of processing capabilities of the user equipment based on the first bandwidth supported by the first network for the first RAT. For example, the capability selection circuitry 1043, shown and described above in connection with FIG. 10, may provide a means to select a first processing capability of a plurality of processing capabilities of the user equipment based on (e.g., based on the determination of) the first bandwidth supported by the first network for the first RAT. In some examples, the user equipment may select a processing capability for the first RAT that supports a bandwidth that does not exceed the first bandwidth.

In some examples, the plurality of processing capabilities may include the first processing capability, and a second processing capability. In some examples, the first processing capability supports up to a first bandwidth threshold (e.g., B1 MHz) for the first RAT, and a first quantity (e.g., L3) of multiple-input multiple-output (MIMO) layers for a second RAT. In some examples, the second processing capability supports up to a second bandwidth threshold (e.g., B3 MHz) for the first RAT that is greater than the first bandwidth threshold, and a second quantity (e.g., L1) of MIMO layers for the second RAT that is less than the first quantity of MIMO layers. In some examples, the second RAT may include a 3GPP long term evolution (LTE) technology.

In some examples, the first processing capability supports a first quantity of multiple-input multiple-output (MIMO) layers for a second RAT and a first bandwidth for the first RAT, wherein the first RAT supports higher bandwidths than the second RAT. In some examples, the second processing capability supports a second quantity of MIMO layers for the second RAT and a second bandwidth for the first RAT, wherein the second quantity of MIMO layers is different from the first quantity of MIMO layers and the second bandwidth is different from the first bandwidth.

At block 1106, the user equipment may transmit an indication of the first processing capability. For example, the capability selection circuitry 1043, in cooperation with the communication and processing circuitry 1041 and the transceiver 1010 shown and described above in connection with FIG. 10, may provide a means to transmit an indication of the first processing capability.

In some examples, the user equipment may transmit a capability message that may include the indication. In some examples, the indication may include a user equipment radio capability identifier (URCID).

In some examples, the user equipment may receive a configuration for evolved-universal terrestrial radio access network—new radio dual connectivity (EN-DC) from a base station of the first network after transmitting the indication.

In some examples, the user equipment may determine a second bandwidth supported by a second network (e.g., a network within a different country, region, etc.) for the first RAT, select a second processing capability of the plurality of processing capabilities of the user equipment based on the determining the second bandwidth supported by the second network for the first RAT, and transmit an indication of the second processing capability.

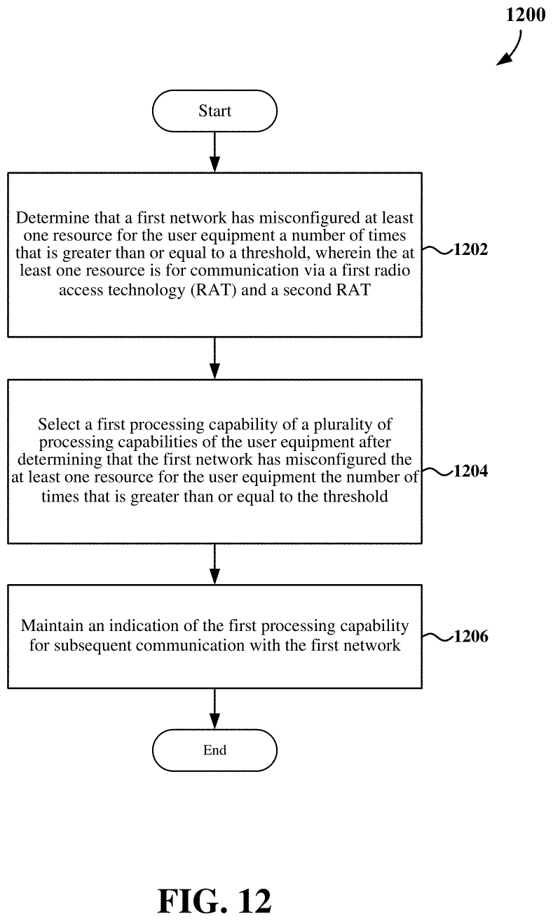

FIG. 12 is a flow chart illustrating an example method 1200 for wireless communication according to some aspects. As described below, some or all illustrated features may be omitted in a particular implementation within the scope of the present disclosure, and some illustrated features may not be required for implementation of all examples. In some examples, the method 1200 may be carried out by the user equipment 1000 illustrated in FIG. 10 or by any suitable apparatus or means for carrying out the functions or algorithm described below.

At block 1202, a user equipment may determine that a first network has misconfigured at least one resource for the user equipment a number of times that is greater than or equal to a threshold, wherein the at least one resource is for communication via a first radio access technology (RAT) and a second RAT. For example, the configuration processing circuitry 1042 in cooperation with the communication and processing circuitry 1041 and the transceiver 1010, shown and described above in connection with FIG. 10, may provide a means to determine that a first network (e.g., a network within a particular country, region, etc.) has misconfigured at least one resource for the user equipment a number of times that is greater than or equal to a threshold.

In some examples, the first RAT may include a third generation partnership project (3GPP) new radio (NR) technology. In some examples, the second RAT may include a 3GPP long term evolution (LTE) technology.

At block 1204, the user equipment may select a first processing capability of a plurality of processing capabilities of the user equipment based on the determining that the first network has misconfigured the at least one resource for the user equipment the number of times that is greater than or equal to the threshold. For example, the capability selection circuitry 1043, shown and described above in connection with FIG. 10, may provide a means to select a first processing capability of a plurality of processing capabilities of the user equipment based on the determining that the first network has misconfigured the at least one resource for the user equipment the number of times that is greater than or equal to the threshold.

In some examples, the plurality of processing capabilities may include the first processing capability, and a second processing capability. In some examples, the first processing capability supports up to a first bandwidth threshold for the first RAT, and a first quantity of multiple-input multiple-output (MIMO) layers for the second RAT. In some examples, the second processing capability supports up to a second bandwidth threshold for the first RAT that is greater than the first bandwidth threshold, and a second quantity of MIMO layers for the second RAT that is less than the first quantity of MIMO layers.

In some examples, the first processing capability supports a first quantity of multiple-input multiple-output (MIMO) layers for a second RAT and a first bandwidth for the first RAT, wherein the first RAT supports higher bandwidths than the second RAT. In some examples, the second processing capability supports a second quantity of MIMO layers for the second RAT and a second bandwidth for the first RAT, wherein the second quantity of MIMO layers is different from the first quantity of MIMO layers and the second bandwidth is different from the first bandwidth.

In some examples, the selection of the first processing capability by the user equipment may include identifying a first bandwidth associated with at least one successful configuration of the user equipment by the first network, and selecting a processing capability for the first RAT that supports a bandwidth that does not exceed the first bandwidth.

In some examples, the first bandwidth is for a sub-6 GHz band. In some examples, the first bandwidth is for a millimeter wave (mmW) band.

In some examples, to identify the first bandwidth associated with at least one successful configuration of the user equipment by the first network, the user equipment may retrieve information indicative of the at least one successful configuration from a server, and selecting the first bandwidth based on the information.

In some examples, to identify the first bandwidth associated with at least one successful configuration of the user equipment by the first network, the user equipment may retrieve, from a memory of the user equipment, information collected by the user equipment indicative of successful configurations of the user equipment by the first network, and select the first bandwidth based on the information from the memory.

In some examples, to identify the first bandwidth associated with at least one successful configuration of the user equipment by the first network, the user equipment may identify a public land mobile network (PLMN) advertised by the first network, and identify successful configurations of the user equipment by the first network that are associated with the PLMN.

In some examples, to identify the first bandwidth associated with at least one successful configuration of the user equipment by the first network, the user equipment may identify a radio frequency (RF) band of the first network, and identify successful configurations of the user equipment by the first network that are associated with the RF band.

In some examples, to identify the first bandwidth associated with at least one successful configuration of the user equipment by the first network, the user equipment may identify a tracking area identifier (TAI) advertised by the first network, and identify successful configurations of the user equipment by the first network that are associated with the TAI.

In some examples, to identify the first bandwidth associated with at least one successful configuration of the user equipment by the first network, the user equipment may identify a location of the user equipment, and identify successful configurations of the user equipment by the first network that are associated with the location.

At block 1206, the user equipment may maintain an indication of the first processing capability for subsequent communication with the first network. For example, the capability selection circuitry 1043 (optionally in cooperation with the communication and processing circuitry 1041 and the transceiver 1010), shown and described above in connection with FIG. 10, may provide a means to maintain an indication of the first processing capability for subsequent communication with the first network.

In some examples, the maintaining of the indication of the first processing capability for the subsequent communication with the first network by the user equipment may include collecting information indicative of successful configurations of the user equipment by the first network, and generating the indication from the collecting of the information.

In some examples, the maintaining of the indication of the first processing capability for the subsequent communication with the first network by the user equipment may include collecting information indicative of unsuccessful configurations of the user equipment by the first network, and generating the indication from the collecting of the information.

In some examples, the maintaining of the indication of the first processing capability for the subsequent communication with the first network by the user equipment may include transmitting the indication to a server. In some examples, the indication may include a user equipment radio capability identifier (URCID).

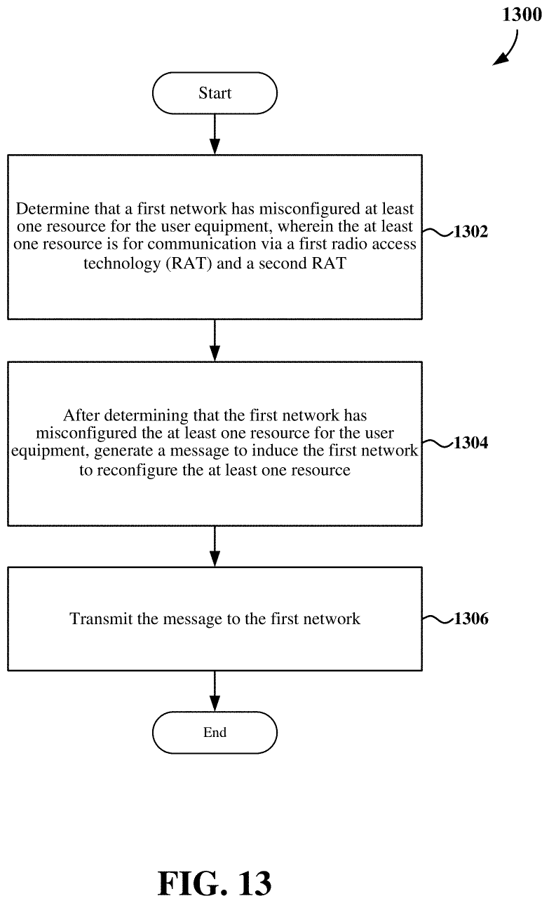

FIG. 13 is a flow chart illustrating an example method 1300 for wireless communication according to some aspects. As described below, some or all illustrated features may be omitted in a particular implementation within the scope of the present disclosure, and some illustrated features may not be required for implementation of all examples. In some examples, the method 1300 may be carried out by the user equipment 1000 illustrated in FIG. 10 or by any suitable apparatus or means for carrying out the functions or algorithm described below.

At block 1302, a user equipment may determine that a first network has misconfigured at least one resource for the user equipment, wherein the at least one resource is for communication via a first radio access technology (RAT) and a second RAT. For example, the configuration processing circuitry 1042 in cooperation with the communication and processing circuitry 1041 and the transceiver 1010, shown and described above in connection with FIG. 10, may provide a means to determine that a first network has misconfigured at least one resource for the user equipment.

In some examples, the first RAT may include a third generation partnership project (3GPP) new radio (NR) technology. In some examples, the second RAT may include a 3GPP long term evolution (LTE) technology.

In some examples, to determine that the first network has misconfigured the at least one resource for the user equipment, the user equipment may receive a configuration message from the first network, wherein the configuration message specifies a first bandwidth for the first RAT and a first quantity of multiple-input multiple-output (MIMO) layers for the second RAT, and determine that the user equipment does not concurrently support both the first bandwidth for the first RAT and the first quantity of MIMO layers for the second RAT. In some examples, the configuration message may include a radio resource control (RRC) configuration.

At block 1304, the user equipment may, based on the determining that the first network has misconfigured the at least one resource for the user equipment, generate a message to induce the first network to reconfigure the at least one resource. For example, the configuration processing circuitry 1042, shown and described above in connection with FIG. 10, may provide a means to, based on the determining that the first network has misconfigured the at least one resource for the user equipment, generate a message to induce the first network to reconfigure the at least one resource.

In some examples, the user equipment may generate a measurement report that may include a channel quality indication for a cell of the second RAT that is less than or equal to a threshold channel quality, wherein the threshold channel quality is defined for inducing the first network to reconfigure the at least one resource.

In some examples, the user equipment may generate a measurement report that may include a channel quality indication for a cell of the second RAT, wherein the channel quality indication has a value of zero.

At block 1306, the user equipment may transmit the message to the first network.

For example, the configuration processing circuitry 1042 in cooperation with the communication and processing circuitry 1041 and the transceiver 1010, shown and described above in connection with FIG. 10, may provide a means to transmit the message to the first network.

In some examples, the message may include a request for the first network to reduce a quantity of configured multiple-input multiple-output (MIMO) layers for the second RAT. In some examples, the message may include a request for the first network to increase a configured bandwidth for the first RAT.

In some examples, the message may include a request to the first network to release at least one cell of the second RAT. In some examples, the message may include a user equipment assistance information (UEAssistanceInformation) message that includes the request.

In some examples, the generation of the message by the user equipment may include determining that a bandwidth requirement for the first RAT is greater than or equal to a threshold, and including in the message a request to the first network to reduce a quantity of multiple-input multiple-output (MIMO) layers of the second RAT based on the determining that the bandwidth requirement for the first RAT is greater than or equal to the threshold. In some examples, the message may include a user equipment assistance information (UEAssistanceInformation) message that includes the request.

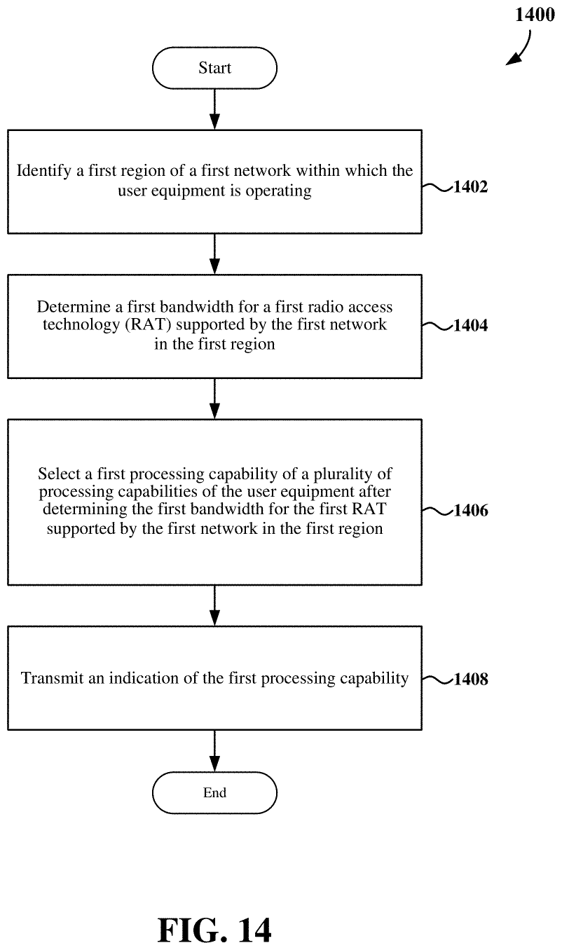

FIG. 14 is a flow chart illustrating an example method 1400 for wireless communication according to some aspects. As described below, some or all illustrated features may be omitted in a particular implementation within the scope of the present disclosure, and some illustrated features may not be required for implementation of all examples. In some examples, the method 1400 may be carried out by the user equipment 1000 illustrated in FIG. 10 or by any suitable apparatus or means for carrying out the functions or algorithm described below.

At block 1402, a user equipment may identify a first region of a first network within which the user equipment is operating. For example, the configuration processing circuitry 1042 in cooperation with the communication and processing circuitry 1041 and the transceiver 1010, shown and described above in connection with FIG. 10, may provide a means to identify a first region of a first network within which the user equipment is operating.

At block 1404, the user equipment may determine a first bandwidth for a first radio access technology (RAT) supported by the first network in the first region. For example, the configuration processing circuitry 1042 (optionally in cooperation with the communication and processing circuitry 1041 and the transceiver 1010), shown and described above in connection with FIG. 10, may provide a means to determine a first bandwidth for a first radio access technology (RAT) supported by the first network in the first region. In some examples, the first RAT may include a third generation partnership project (3GPP) new radio (NR) technology.

At block 1406, the user equipment may select a first processing capability of a plurality of processing capabilities of the user equipment based on the first bandwidth for the first RAT supported by the first network in the first region. For example, the capability selection circuitry 1043, shown and described above in connection with FIG. 10, may provide a means to select a first processing capability of a plurality of processing capabilities of the user equipment based on (e.g., based on the determination of) the first bandwidth for the first RAT supported by the first network in the first region.

In some examples, the plurality of processing capabilities may include the first processing capability, and a second processing capability. In some examples, the first processing capability supports up to a first bandwidth threshold for the first RAT, and a first quantity of multiple-input multiple-output (MIMO) layers for a second RAT. In some examples, the second processing capability supports up to a second bandwidth threshold for the first RAT that is greater than the first bandwidth threshold, and a second quantity of MIMO layers for the second RAT that is less than the first quantity of MIMO layers.

In some examples, the first processing capability supports a first quantity of third generation partnership project (3GPP) long term evolution (LTE) multiple-input multiple-output (MIMO) layers and a first 3GPP new radio (NR) bandwidth, and the second processing capability supports a second quantity of 3GPP LTE MIMO layers different from the first quantity of 3GPP LTE MIMO layers and a second 3GPP NR bandwidth different from the first 3GPP NR bandwidth.

In some examples, the selection of the first processing capability by the user equipment may include identifying a first bandwidth associated with at least one successful configuration of the user equipment in the first region by the first network, and selecting a processing capability for the first RAT that supports a bandwidth that does not exceed the first bandwidth.

In some examples, to identify the first bandwidth associated with the at least one successful configuration of the user equipment in the first region by the first network, the user equipment may retrieve information indicative of the at least one successful configuration from a server, and selecting the first bandwidth based on the retrieving of the information.

In some examples, to identify the first bandwidth associated with the at least one successful configuration of the user equipment in the first region by the first network, the user equipment may retrieve, from a memory of the user equipment, information collected by the user equipment indicative of successful configurations of the user equipment in the first region by the first network, and select the first bandwidth based on the information from the memory.

In some examples, to identify the first bandwidth associated with the at least one successful configuration of the user equipment in the first region by the first network, the user equipment may identify a cell identify (cell ID) advertised by the first network in the first region, and identify at least one bandwidth supported by the first network in the first region that is associated with the cell ID.

In some examples, to identify the first bandwidth associated with the at least one successful configuration of the user equipment in the first region by the first network, the user equipment may identify a radio frequency (RF) band of the first network in the first region, and identify at least one bandwidth supported by the first network in the first region that is associated with the RF band.

In some examples, to identify the first bandwidth associated with the at least one successful configuration of the user equipment in the first region by the first network, the user equipment may identify a tracking area identifier (TAI) advertised by the first network in the first region, and identify at least one bandwidth supported by the first network in the first region that is associated with the TAI.

In some examples, to identify the first bandwidth associated with the at least one successful configuration of the user equipment in the first region by the first network, the user equipment may identify a location of the user equipment in the first region, and identify at least one bandwidth supported by the first network in the first region that is associated with the location.

At block 1408, the user equipment may transmit an indication of the first processing capability. For example, the capability selection circuitry 1043, in cooperation with the communication and processing circuitry 1041 and the transceiver 1010 shown and described above in connection with FIG. 10, may provide a means to transmit an indication of the first processing capability.

In some examples, the user equipment may transmit a capability message that may include the indication. In some examples, the indication may include a user equipment radio capability identifier (URCID).

In some examples, the user equipment may maintain information indicative of at least one second bandwidth supported by the first network in the first region and at least one third bandwidth supported by the first network in a second region.

In some examples, the maintaining of the information by the user equipment may include collecting information indicative of the at least one second bandwidth supported by the first network in the first region and the at least one third bandwidth supported by the first network in a second region, and generating the indication from the collecting of the information. In some examples, maintaining the information may include transmitting the information to a server.

In some examples, the maintaining of the information by the user equipment may include retrieving, from a server, information indicative of the at least one second bandwidth supported by the first network in the first region and the at least one third bandwidth supported by the first network in a second region, and generating the indication from the information from the server.

In one configuration, the UE 1000 includes means for determining a first bandwidth supported by a first network for a first radio access technology (RAT), means for selecting a first processing capability of a plurality of processing capabilities of the user equipment based on the first bandwidth supported by the first network for the first RAT, and means for transmitting an indication of the first processing capability. In one configuration, the UE 1000 includes means for determining that a first network has misconfigured at least one resource for the user equipment a number of times that is greater than or equal to a threshold, wherein the at least one resource is for communication via a first radio access technology (RAT) and a second RAT, means for selecting a first processing capability of a plurality of processing capabilities of the user equipment based on the determining that the first network has misconfigured the at least one resource for the user equipment the number of times that is greater than or equal to the threshold, and means for maintaining an indication of the first processing capability for subsequent communication with the first network. In one aspect, the aforementioned means may be the processor 1004 shown in FIG. 10 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable medium 1006, or any other suitable apparatus or means described in any one or more of FIGS. 1, 2, 4, 5, 6, 9, and 10, and utilizing, for example, the methods and/or algorithms described herein in relation to FIGS. 11-14.

The methods shown in FIGS. 11-14 may include additional aspects, such as any single aspect or any combination of aspects described below and/or in connection with one or more other processes described elsewhere herein.

In some examples, a method of wireless communication at a user equipment may include determining that a first network has misconfigured at least one resource for the user equipment. The at least one resource may be for communication via a first radio access technology (RAT) and a second RAT. The method may also include, based on the determining that the first network has misconfigured the at least one resource for the user equipment, generating a message to induce the first network to reconfigure the at least one resource, and transmitting the message to the first network.

In some examples, a user equipment may include a transceiver, a memory, and a processor communicatively coupled to the transceiver and the memory. The processor and the memory may be configured to determine that a first network has misconfigured at least one resource for the user equipment. The at least one resource may be for communication via a first radio access technology (RAT) and a second RAT. The processor and the memory may also be configured to generate a message, based on the determining that the first network has misconfigured the at least one resource for the user equipment, to induce the first network to reconfigure the at least one resource, and transmit the message to the first network via the transceiver.

In some examples, a user equipment may include means for determining that a first network has misconfigured at least one resource for the user equipment. The at least one resource may be for communication via a first radio access technology (RAT) and a second RAT. The user equipment may also include means for generating a message, based on the determining that the first network has misconfigured the at least one resource for the user equipment, to induce the first network to reconfigure the at least one resource, and means for transmitting the message to the first network.

In some examples, an article of manufacture for use by a user equipment includes a computer-readable medium having stored therein instructions executable by one or more processors of the user equipment to determine that a first network has misconfigured at least one resource for the user equipment. The at least one resource may be for communication via a first radio access technology (RAT) and a second RAT. The computer-readable medium may also have stored therein instructions executable by one or more processors of the user equipment to generate a message, based on the determining that the first network has misconfigured the at least one resource for the user equipment, to induce the first network to reconfigure the at least one resource, and transmit the message to the first network.

In some examples, a method of wireless communication at a user equipment may include identifying a first region of a first network within which the user equipment is operating, determining a first bandwidth for a first radio access technology (RAT) supported by the first network in the first region, selecting a first processing capability of a plurality of processing capabilities of the user equipment based on the first bandwidth for the first RAT supported by the first network in the first region, and transmitting an indication of the first processing capability.

In some examples, a user equipment may include a transceiver, a memory, and a processor communicatively coupled to the transceiver and the memory. The processor and the memory may be configured to identify a first region of a first network within which the user equipment is operating, determine a first bandwidth for a first radio access technology (RAT) supported by the first network in the first region, select a first processing capability of a plurality of processing capabilities of the user equipment based on the first bandwidth for the first RAT supported by the first network in the first region, and transmit an indication of the first processing capability via the transceiver.

In some examples, a user equipment may include means for identifying a first region of a first network within which the user equipment is operating, means for determining a first bandwidth for a first radio access technology (RAT) supported by the first network in the first region, means for selecting a first processing capability of a plurality of processing capabilities of the user equipment based on the first bandwidth for the first RAT supported by the first network in the first region, and means for transmitting an indication of the first processing capability.

In some examples, an article of manufacture for use by a user equipment includes a computer-readable medium having stored therein instructions executable by one or more processors of the user equipment to identify a first region of a first network within which the user equipment is operating, determine a first bandwidth for a first radio access technology (RAT) supported by the first network in the first region, select a first processing capability of a plurality of processing capabilities of the user equipment based on the first bandwidth for the first RAT supported by the first network in the first region, and transmit an indication of the first processing capability.

The following provides an overview of several aspects of the present disclosure.

Aspect 1: A method for wireless communication at a user equipment, the method comprising: determining a first bandwidth supported by a first network for a first radio access technology (RAT); selecting a first processing capability of a plurality of processing capabilities of the user equipment based on the first bandwidth supported by the first network for the first RAT; and transmitting an indication of the first processing capability.

Aspect 2: The method of aspect 1, wherein the plurality of processing capabilities comprises: the first processing capability; and a second processing capability.

Aspect 3: The method of aspect 2, wherein the first processing capability supports up to: a first bandwidth threshold for the first RAT; and a first quantity of multiple-input multiple-output (MIMO) layers for a second RAT.

Aspect 4: The method of aspect 3, wherein the second processing capability supports up to: a second bandwidth threshold for the first RAT that is greater than the first bandwidth threshold; and a second quantity of MIMO layers for the second RAT that is less than the first quantity of MIMO layers.

Aspect 5: The method of any of aspects 2 through 4, wherein: the first processing capability supports a first quantity of multiple-input multiple-output (MIMO) layers for a second RAT and the first bandwidth for the first RAT, wherein the first RAT supports higher bandwidths than the second RAT; and the second processing capability supports a second quantity of MIMO layers for the second RAT and a second bandwidth for the first RAT, wherein the second quantity of MIMO layers is different from the first quantity of MIMO layers and the second bandwidth is different from the first bandwidth.

Aspect 6: The method of any of aspects 1 through 5, wherein the selecting the first processing capability comprises: selecting a processing capability for the first RAT that supports a bandwidth that does not exceed the first bandwidth.

Aspect 7: The method of any of aspects 1 through 6, wherein the determining the first bandwidth supported by the first network for the first RAT comprises: identifying a public land mobile network (PLMN) advertised by the first network; and identifying a bandwidth associated with the PLMN.

Aspect 8: The method of any of aspects 1 through 7, wherein the determining the first bandwidth supported by the first network for the first RAT comprises: identifying a radio frequency (RF) band of the first network; and identifying a bandwidth associated with the RF band.

Aspect 9: The method of any of aspects 1 through 8, wherein the determining the first bandwidth supported by the first network for the first RAT comprises: identifying a tracking area identifier (TAI) advertised by the first network; and identifying a bandwidth associated with the TAI.

Aspect 10: The method of any of aspects 1 through 9, wherein the determining the first bandwidth supported by the first network for the first RAT comprises: identifying a location of the user equipment; and identifying a bandwidth associated with the location.

Aspect 11: The method of any of aspects 1 through 10, wherein the determining the first bandwidth supported by the first network for the first RAT comprises: retrieving information indicative of the first bandwidth from a server; collecting information indicative of the first bandwidth based on a plurality of accesses of the first network by the user equipment; or retrieving defined information indicative of the first bandwidth from a memory of the user equipment.

Aspect 12: The method of any of aspects 1 through 11, further comprising: receiving a configuration for evolved-universal terrestrial radio access network—new radio dual connectivity (EN-DC) from a base station of the first network after transmitting the indication.

Aspect 13: The method of any of aspects 1 through 12, further comprising: determining a second bandwidth supported by a second network for the first RAT; selecting a second processing capability of the plurality of processing capabilities of the user equipment based on the second bandwidth supported by the second network for the first RAT; and transmitting an indication of the second processing capability.

Aspect 14: The method of any of aspects 1 through 13, wherein the transmitting the indication comprises: transmitting a capability message comprising the indication.

Aspect 16: A method for wireless communication at a user equipment, the method comprising: determining that a first network has misconfigured at least one resource for the user equipment a number of times that is greater than or equal to a threshold, wherein the at least one resource is for communication via a first radio access technology (RAT) and a second RAT; selecting a first processing capability of a plurality of processing capabilities of the user equipment based on the determining that the first network has misconfigured the at least one resource for the user equipment the number of times that is greater than or equal to the threshold; and maintaining an indication of the first processing capability for subsequent communication with the first network.

Aspect 17: The method of aspect 16, wherein the plurality of processing capabilities comprises: the first processing capability; and a second processing capability.

Aspect 18: The method of aspect 17, wherein the first processing capability supports up to: a first bandwidth threshold for the first RAT; and a first quantity of multiple-input multiple-output (MIMO) layers for the second RAT.

Aspect 19: The method of aspect 18, wherein the second processing capability supports up to: a second bandwidth threshold for the first RAT that is greater than the first bandwidth threshold; and a second quantity of MIMO layers for the second RAT that is less than the first quantity of MIMO layers.

Aspect 20: The method of any of aspects 17 through 19, wherein: the first processing capability supports a first quantity of multiple-input multiple-output (MIMO) layers for the second RAT and a first bandwidth for the first RAT, wherein the first RAT supports higher bandwidths than the second RAT; and the second processing capability supports a second quantity of MIMO layers for the second RAT and a second bandwidth for the first RAT, wherein the second quantity of MIMO layers is different from the first quantity of MIMO layers and the second bandwidth is different from the first bandwidth.

Aspect 21: The method of any of aspects 16 through 20, wherein the selecting the first processing capability comprises: identifying a first bandwidth associated with at least one successful configuration of the user equipment by the first network; and selecting a processing capability for the first RAT that supports a bandwidth that does not exceed the first bandwidth.

Aspect 22: The method of aspect 21, wherein the identifying the first bandwidth associated with the at least one successful configuration of the user equipment by the first network comprises: retrieving information indicative of the at least one successful configuration from a server; and selecting the first bandwidth based on the information.

Aspect 23: The method of aspect 21, wherein the identifying the first bandwidth associated with the at least one successful configuration of the user equipment by the first network comprises: retrieving, from a memory of the user equipment, information collected by the user equipment indicative of successful configurations of the user equipment by the first network; and selecting the first bandwidth based on the information from the memory.

Aspect 24: The method of aspect 21, wherein the identifying the first bandwidth associated with the at least one successful configuration of the user equipment by the first network comprises: identifying a public land mobile network (PLMN) advertised by the first network; and identifying successful configurations of the user equipment by the first network that are associated with the PLMN.

Aspect 25: The method of aspect 21, wherein the identifying the first bandwidth associated with the at least one successful configuration of the user equipment by the first network comprises: identifying a radio frequency (RF) band of the first network; and identifying successful configurations of the user equipment by the first network that are associated with the RF band.

Aspect 26: The method of aspect 21, wherein the identifying the first bandwidth associated with the at least one successful configuration of the user equipment by the first network comprises: identifying a tracking area identifier (TAI) advertised by the first network; and identifying successful configurations of the user equipment by the first network that are associated with the TAI.

Aspect 27: The method of aspect 21, wherein the identifying the first bandwidth associated with the at least one successful configuration of the user equipment by the first network comprises: identifying a location of the user equipment; and identifying successful configurations of the user equipment by the first network that are associated with the location.

Aspect 28: The method of any of aspects 16 through 27, wherein the maintaining the indication of the first processing capability for the subsequent communication with the first network comprises: collecting information indicative of successful configurations of the user equipment by the first network; and generating the indication from the collecting the information.

Aspect 29: The method of any of aspects 16 through 28, wherein the maintaining the indication of the first processing capability for the subsequent communication with the first network comprises: collecting information indicative of unsuccessful configurations of the user equipment by the first network; and generating the indication from the collecting the information.

Aspect 30: A user equipment comprising: a transceiver configured to communicate with a radio access network, a memory, and a processor communicatively coupled to the transceiver and the memory, wherein the processor and the memory are configured to perform any one of aspects 1 through 14.

Aspect 31: An apparatus configured for wireless communication comprising at least one means for performing any one of aspects 1 through 14.

Aspect 32: A non-transitory computer-readable medium storing computer-executable code, comprising code for causing an apparatus to perform any one of aspects 1 through 14.

Aspect 33: A user equipment comprising: a transceiver configured to communicate with a radio access network, a memory, and a processor communicatively coupled to the transceiver and the memory, wherein the processor and the memory are configured to perform any one of aspects 16 through 29.

Aspect 34: An apparatus configured for wireless communication comprising at least one means for performing any one of aspects 16 through 29.

Aspect 35: A non-transitory computer-readable medium storing computer-executable code, comprising code for causing an apparatus to perform any one of aspects 16 through 29.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-14 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4, 5, 6, 9, and 10 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communication at a user equipment, the method comprising:
determining a first bandwidth supported by a first network for a first radio access technology (RAT);
selecting a first processing capability of a plurality of processing capabilities of the user equipment based on the first bandwidth supported by the first network for the first RAT; and
transmitting an indication of the first processing capability.

2. The method of claim 1, wherein the plurality of processing capabilities comprises:
the first processing capability; and
a second processing capability.

3. The method of claim 2, wherein the first processing capability supports up to:
a first bandwidth threshold for the first RAT; and
a first quantity of multiple-input multiple-output (MIMO) layers for a second RAT.

4. The method of claim 3, wherein the second processing capability supports up to:
a second bandwidth threshold for the first RAT that is greater than the first bandwidth threshold; and
a second quantity of MIMO layers for the second RAT that is less than the first quantity of MIMO layers.

5. The method of claim 2, wherein:
the first processing capability supports a first quantity of multiple-input multiple-output (MIMO) layers for a second RAT and the first bandwidth for the first RAT, wherein the first RAT supports higher bandwidths than the second RAT; and
the second processing capability supports a second quantity of MIMO layers for the second RAT and a second bandwidth for the first RAT, wherein the second quantity of MIMO layers is different from the first quantity of MIMO layers and the second bandwidth is different from the first bandwidth.

6. The method of claim 1, wherein the selecting the first processing capability comprises:
selecting a processing capability for the first RAT that supports a bandwidth that does not exceed the first bandwidth.

7. The method of claim 1, wherein the determining the first bandwidth supported by the first network for the first RAT comprises:
identifying a public land mobile network (PLMN) advertised by the first network; and
identifying a bandwidth associated with the PLMN.

8. The method of claim 1, wherein the determining the first bandwidth supported by the first network for the first RAT comprises:
identifying a radio frequency (RF) band of the first network; and
identifying a bandwidth associated with the RF band.

9. The method of claim 1, wherein the determining the first bandwidth supported by the first network for the first RAT comprises:
identifying a tracking area identifier (TAI) advertised by the first network; and
identifying a bandwidth associated with the TAI.

10. The method of claim 1, wherein the determining the first bandwidth supported by the first network for the first RAT comprises:
identifying a location of the user equipment; and
identifying a bandwidth associated with the location.

11. The method of claim 1, wherein the determining the first bandwidth supported by the first network for the first RAT comprises:
retrieving information indicative of the first bandwidth from a server;
collecting information indicative of the first bandwidth based on a plurality of accesses of the first network by the user equipment; or
retrieving defined information indicative of the first bandwidth from a memory of the user equipment.

12. The method of claim 1, further comprising:
receiving a configuration for evolved-universal terrestrial radio access network—new radio dual connectivity (EN-DC) from a base station of the first network after transmitting the indication.

13. The method of claim 1, further comprising:
determining a second bandwidth supported by a second network for the first RAT;
selecting a second processing capability of the plurality of processing capabilities of the user equipment based on the second bandwidth supported by the second network for the first RAT; and
transmitting an indication of the second processing capability.

14. The method of claim 1, wherein the transmitting the indication comprises:
transmitting a capability message comprising the indication.

15. A user equipment, comprising:
a transceiver;
a memory; and
a processor communicatively coupled to the transceiver and the memory, wherein the processor and the memory are configured to:
determine a first bandwidth supported by a first network for a first radio access technology (RAT);
select a first processing capability of a plurality of processing capabilities of the user equipment based on the first bandwidth supported by the first network for the first RAT; and
transmit an indication of the first processing capability via the transceiver.

16. A method for wireless communication at a user equipment, the method comprising:
determining that a first network has misconfigured at least one resource for the user equipment a number of times that is greater than or equal to a threshold, wherein the at least one resource is for communication via a first radio access technology (RAT) and a second RAT;
selecting a first processing capability of a plurality of processing capabilities of the user equipment based on the determining that the first network has misconfigured the at least one resource for the user equipment the number of times that is greater than or equal to the threshold; and
maintaining an indication of the first processing capability for subsequent communication with the first network.

17. The method of claim 16, wherein the plurality of processing capabilities comprises:
the first processing capability; and
a second processing capability.

18. The method of claim 17, wherein the first processing capability supports up to:
a first bandwidth threshold for the first RAT; and
a first quantity of multiple-input multiple-output (MIMO) layers for the second RAT.

19. The method of claim 18, wherein the second processing capability supports up to:
a second bandwidth threshold for the first RAT that is greater than the first bandwidth threshold; and
a second quantity of MIMO layers for the second RAT that is less than the first quantity of MIMO layers.

20. The method of claim 17, wherein:
the first processing capability supports a first quantity of multiple-input multiple-output (MIMO) layers for the second RAT and a first bandwidth for the first RAT, wherein the first RAT supports higher bandwidths than the second RAT; and
the second processing capability supports a second quantity of MIMO layers for the second RAT and a second bandwidth for the first RAT, wherein the second quantity of MIMO layers is different from the first quantity of MIMO layers and the second bandwidth is different from the first bandwidth.

21. The method of claim 16, wherein the selecting the first processing capability comprises:
identifying a first bandwidth associated with at least one successful configuration of the user equipment by the first network; and
selecting a processing capability for the first RAT that supports a bandwidth that does not exceed the first bandwidth.

22. The method of claim 21, wherein the identifying the first bandwidth associated with the at least one successful configuration of the user equipment by the first network comprises:
retrieving information indicative of the at least one successful configuration from a server; and
selecting the first bandwidth based on the information.

23. The method of claim 21, wherein the identifying the first bandwidth associated with the at least one successful configuration of the user equipment by the first network comprises:
retrieving, from a memory of the user equipment, information collected by the user equipment indicative of successful configurations of the user equipment by the first network; and
selecting the first bandwidth based on the information from the memory.

24. The method of claim 21, wherein the identifying the first bandwidth associated with the at least one successful configuration of the user equipment by the first network comprises:
identifying a public land mobile network (PLMN) advertised by the first network; and
identifying successful configurations of the user equipment by the first network that are associated with the PLMN.

25. The method of claim 21, wherein the identifying the first bandwidth associated with the at least one successful configuration of the user equipment by the first network comprises:
identifying a radio frequency (RF) band of the first network; and
identifying successful configurations of the user equipment by the first network that are associated with the RF band.

26. The method of claim 21, wherein the identifying the first bandwidth associated with the at least one successful configuration of the user equipment by the first network comprises:
identifying a tracking area identifier (TAI) advertised by the first network; and
identifying successful configurations of the user equipment by the first network that are associated with the TAI.

27. The method of claim 21, wherein the identifying the first bandwidth associated with the at least one successful configuration of the user equipment by the first network comprises:
identifying a location of the user equipment; and
identifying successful configurations of the user equipment by the first network that are associated with the location.

28. The method of claim 16, wherein the maintaining the indication of the first processing capability for the subsequent communication with the first network comprises:
collecting information indicative of successful configurations of the user equipment by the first network; and
generating the indication from the collecting the information.

29. The method of claim 16, wherein the maintaining the indication of the first processing capability for the subsequent communication with the first network comprises:
collecting information indicative of unsuccessful configurations of the user equipment by the first network; and
generating the indication from the collecting the information.

30. A user equipment, comprising:
a transceiver;
a memory; and
a processor communicatively coupled to the transceiver and the memory, wherein the processor and the memory are configured to:
determine that a first network has misconfigured at least one resource for the user equipment a number of times that is greater than or equal to a threshold, wherein the at least one resource is for communication via a first radio access technology (RAT) and a second RAT;
select a first processing capability of a plurality of processing capabilities of the user equipment based on the determination that the first network has misconfigured the at least one resource for the user equipment the number of times that is greater than or equal to the threshold; and
maintain an indication of the first processing capability for subsequent communication with the first network.
